(19) United States
(12) Patent Application Publication
(10) Pub. No.: US 2007/0076771 A1
(43) Pub. Date: Apr. 5, 2007

(54) Method and apparatus for controlling extinction ratio of light-emitting device

(75) Inventors: Takahiro Fujimoto, Kawasaki (JP); Kensuke Matsui, Kawasaki (JP); Tetsuya Kiyonaga, Kawasaki (JP); Hiroshi Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/356,225

(22) Filed: Feb. 17, 2006

(30) Foreign Application Priority Data
Sep. 30, 2005 (JP) 2005-287235

(51) Int. Cl. H01S 3/00

(52) U.S. Cl. 372/38.01; 372/38.04

(57) ABSTRACT

An apparatus for controlling an extinction ratio of a light-emitting device, includes: a temperature detecting unit that detects a temperature of the device; a power detecting unit that detects an optical output power of the device; a modulation-current detecting unit that detects a modulation current input into the device; a POW computing unit that computes a power control value for the device based on the temperature; and an ER computing unit that computes an extinction ratio control value for the device based on the power control value, the optical output power, and the modulation current.

### CROSS-REFERENCE TO RELATED APPLICATIONS

This application is based upon and claims the benefit of priority from the prior Japanese Patent Application No. 2005-287235, filed on Sep. 30, 2005, the entire contents of which are incorporated herein by reference.

### BACKGROUND OF THE INVENTION

1. Field of the Invention

The present invention relates to a technology for keeping the extinction ratio of an optical transmission device constant despite changes in the current versus light output characteristic of a light-emitting device, such as a laser diode, included in the optical transmission device. The extinction ratio means a ratio of the optical output power when the optical transmission device is turned ON to that when the optical transmission device is turned OFF. An optical transmission device having a low extinction ratio cannot block the optical signal completely when it is turned OFF, thereby degrading the transmission quality of the optical signal.

2. Description of the Related Art

In recent years, a large-scale integrated circuit (hereinafter, “LSI”) including a laser diode driver (hereinafter, “LDD”), which can control both the optical output power and the extinction ratio of the optical transmission device for direct modulation at a lower cost and with higher mounting efficiency, has been developed and widely used.

Conventionally, as an automatic power control (hereinafter, “APC”) of the optical output power, it has been suggested to mount a light-receiving element for monitoring the optical output power, such as a monitor photo diode (hereinafter, “MPD”), on the LD and to keep the average output current of the MPD constant. On the other hand, as an automatic control of the extinction ratio, which is also known as the automatic modulation control (hereinafter, “AMC”), it has been suggested to keep the ratio of the output current amplitude of the MPD to the average output current of the MPD constant, or to micro-fluctuate the bias current Ib and the modulation current Ip in a time-sharing manner and keep the ratio of the output variation of the MPD in each time period.

Furthermore, it has been suggested to control both the optical output power and the extinction ratio, which is known as the dual-loop control. FIG. 10A is a block diagram of a basic configuration of an extinction ratio control apparatus employing the dual-loop control. A setting unit 1001 includes an ER setting unit 1002 and a POW setting unit 1003. The ER setting unit 1002 sets the extinction ratio control value (hereinafter, “ER”) of an LDD 1030. The POW setting unit 1003 sets the optical output power control value (hereinafter, “POW”) of the LDD 1030. The LDD 1030 includes an automatic modulation controller (hereinafter, “AMC”) 1031 and an automatic power controller (hereinafter, “APC”) 1032. The AMC 1031 controls the extinction ratio based on the ER set by the ER setting unit 1002. The APC 1032 controls the optical output power based on the POW set by the POW setting unit 1003.

FIGS. 10B and 10C are block diagrams of extinction ratio control apparatuses having an additional function of correcting control errors in addition to the basic configuration shown in FIG. 10A. Extinction ratio control apparatuses 1000A and 1000B respectively include a temperature sensor 1010, a computing unit 1020, the setting unit 1001, and the LDD 1030. The temperature sensor 1010 detects the temperature of the LDD 1030 and outputs the detected temperature (hereinafter, “TEMPMON”) to the computing unit 1020.

The computing unit 1020 includes an ER computing unit 1021 and a POW computing unit 1022 which respectively compute the ER and the POW based on the TEMPMON input from the temperature sensor 1010, and output the ER and the POW to the LDD through the setting unit 1001.

The extinction ratio control apparatus 1000B further improves the precision of the extinction ratio control by feed-backing the detected value of the modulation current Ip (hereinafter, “IPMON”) input into the LDD 1030 to the ER computing unit 1021. With such feed-back control, the extinction ratio is kept constant even when the current versus light output characteristic (hereinafter, “IL characteristic”) of the LD included in the LDD 1030 is varied as a function of the temperature or the usage time (the number of years for which the LD is used).

FIG. 11 is a diagram for explaining the variation of the IL characteristic due to changes in temperature or due to aging of the LD. The horizontal axis of a chart 1100 represents the driving current while the vertical axis of the chart 1100 represents the optical output power. Curves 1101 to 1103 represent the IL characteristic of the LD. The closer the curve is to the head of an arrow 1104, the higher the temperature of the LD is or the longer the usage time of the LD is. The curve 1101, which indicates the IL characteristic of an LD having lower temperature or shorter usage time, is linear after the driving current exceeds a predetermined value (denoted by “I1” in FIG. 11). On the other hand, the curves 1102 and 1103, which indicate the IL characteristics of the LDs having higher temperature or longer usage time, are partially nonlinear.

In addition to the variation of the IL characteristic due to the temperature or the aging, the LD has a tracking error (hereinafter, “TE”) that is specific to each LD and determined at the time of manufacturing. The TE varies as a function of the temperature. FIG. 12 is a diagram for explaining the relation between the temperature and the TE. The horizontal axis of a chart 1200 represents the temperature while the vertical axis of the chart 1200 represents the TE. In the conventional dual-loop control (see, for example, U.S. Pat. No. 6,414,974), the ERs corresponding to various bias currents Ib and/or temperatures are estimated or measured beforehand, and the bias current Ib and/or the temperature are kept in a constant range based on the ER.

FIG. 13 is a diagram for explaining the principle of the conventional dual-loop control. The horizontal axis of a diagram 1300 represents the current value I (Ib, Ip) while the vertical axis of the diagram 1300 represents the optical output power, which is detected by the MPD, of the LD into which a current having the current value I is input. Curves 1301 and 1302 indicate IL characteristics of different LDs.

A low frequency pilot signal is input into the LD. In the pilot signal, a pilot Ib signal for controlling the bias current Ib and a pilot Ip signal for controlling the modulation current Ip are superimposed in a time-sharing manner. For example, when the pilot Ib signal varying within the range of Ib1 is input into the bias current Ib for an LD having the IL characteristic represented by the curve 1301, an output variation ηb due to the pilot Ib signal is detected in the optical output power. The coefficient η indicates the differential coefficient of the curve 1301. On the other hand, when the pilot Ip signal varying within the range of Ip1 is input into the modulation current Ip for the above LD, an output variation ηp due to the pilot Ip signal is detected in the optical output power.

The AMC 1031 keeps the extinction ratio constant by keeping the ratio of ηp/ηb constant. Therefore, in the extinction ratio control of an LD having the IL characteristic represented by the curve 1302, whose differential coefficient η is smaller than that of the curve 1301, the pilot Ib signal varying within the range of Ib2 (>Ib1) is required to obtain the output variation ηb, and the pilot Ip signal varying within the range of Ip2 (>Ip1) is required to obtain the output variation ηp.

However, as described above, the IL characteristic of an LD becomes nonlinear as a function of the temperature or the usage time. FIG. 14 is a diagram for explaining errors involved in the conventional dual-loop control. A chart 1400 shows the curve 1301 shown in the diagram 1300 of FIG. 13, and a curve 1401 indicating a degraded curve 1302 (denoted by a dotted line) that has become nonlinear after the current value exceeds a predetermined value. An LD having the IL characteristic represented by the curve 1401 and an LD having the IL characteristic represented by the curve 1302 require the same amplitude of the pilot Ib signal to output the same output variation ηb. However, the former LD requires a larger amplitude of the pilot Ip signal, which is larger than that of the latter LD by ΔI, to output the same output variation ηp. In other words, if the ratio of ηp/ηb is kept constant, a modulation current Ip larger than that for the latter LD by ΔI is input into the former LD, thereby increasing the extinction ratio disadvantageously.

Furthermore, the optical output power of the LD can be adjusted by a user when it is incorporated into a communication apparatus or an information terminal. FIG. 15 is a diagram for explaining errors involved in the conventional dual-loop control when the optical output power is adjusted. The horizontal axis of a chart 1500 represents the current value while the vertical axis of the chart 1500 represents the optical output power. When the optical output power of an LD is changed, for example, from P1 to P2, differential values in the vicinity of P1 and P2 in the IL characteristic of the LD vary from a curve 1510 (denoted by a dotted line) to a curve 1520 (denoted by a dotted line), and the range of the pilot Ib signal increases from a range 1541 to a range 1542 to increase the output variation ηp due to the pilot Ib signal. In this case, the ratio of the bias current Ib to the modulation current Ip assumed in advance for the AMC control is disadvantageously varied, and therefore the extinction ratio can be deviated from the optimal value.

Furthermore, in the conventional dual-loop control, the optical output power and the extinction ratio are kept within a particular range by estimating the variation of the modulation current Ip due to changes in the bias current Ib and/or temperature, to control the extinction ratio while taking into consideration the correction of the TE. If temperature is used as monitored information in the above control, the optical output power and the extinction ratio are deviated from their optimal points since the temperature can be deviated from the estimated values in different usage environment (such as temperature, humidity, and air flow of a cooling fan).

### SUMMARY OF THE INVENTION

It is an object of the present invention to at least solve the problems in the conventional technology.

An apparatus according to an aspect of the present invention is an apparatus for controlling an extinction ratio of a light-emitting device. The apparatus includes: a temperature detecting unit that detects a temperature of the light-emitting device; a power detecting unit that detects an optical output power of the light-emitting device; a modulation-current detecting unit that detects a modulation current input into the light-emitting device; a power-control-value computing unit that computes a power control value for the light-emitting device based on the temperature; and an extinction-ratio-control-value computing unit that computes an extinction ratio control value for the light-emitting device based on the power control value, the optical output power, and the modulation current.

A method according to another aspect of the present invention is a method of controlling an extinction ratio of a light-emitting device. The method includes: detecting a temperature of the light-emitting device; detecting an optical output power of the light-emitting device; detecting a modulation current input into the light-emitting device; computing a power control value for the light-emitting device based on the temperature; and computing an extinction ratio control value for the light-emitting device based on the power control value, the optical output power, and the modulation current.

A computer-readable recording medium according to still another aspect of the present invention stores a computer program for controlling an extinction ratio of a light-emitting device. The computer program causes a computer to execute: detecting a temperature of the light-emitting device; detecting an optical output power of the light-emitting device; detecting a modulation current input into the light-emitting device; computing a power control value for the light-emitting device based on the temperature; and computing an extinction ratio control value for the light-emitting device based on the power control value, the optical output power, and the modulation current.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a basic configuration of an extinction ratio control apparatus according to an embodiment of the present invention;

FIG. 2 is a diagram for explaining the relation between a monitor photo diode (MPD) characteristic and a laser diode (LD) characteristic;

FIG. 3 is a flowchart of a control process performed by a computing unit shown in FIG. 1;

FIG. 4 is a flowchart of a power control process shown in FIG. 3;

FIG. 5 is a flowchart of an extinction ratio control process shown in FIG. 3;

FIG. 6 is a diagram for explaining the relation between the detected value of the modulation current Ip (IPMON) and the extinction ratio control value (ER);

FIG. 7A is a diagram for explaining the relation between a variable v(opt) and a coefficient ER_0;

FIG. 7B is a diagram for explaining the relation between a variable u(opt) and a coefficient ER_1;

FIG. 8 is a flowchart of a modification of the control process shown in FIG. 3;

FIG. 9 is a block diagram of a detailed configuration of the extinction ratio control apparatus;

FIG. 10A is a block diagram of a basic configuration of an extinction ratio control apparatus employing a dual-loop control;

FIGS. 10B and 10C are block diagrams of extinction ratio control apparatuses having an additional function of correcting control errors;

FIG. 11 is a diagram for explaining the variation of IL characteristic due to changes in temperature or due to aging of the LD;

FIG. 12 is a diagram for explaining the relation between tracking error (TE) and temperature;

FIG. 13 is a diagram for explaining the principle of a conventional dual-loop control;

FIG. 14 is a diagram for explaining errors involved in the conventional dual-loop control; and

FIG. 15 is a diagram for explaining errors involved in the conventional dual-loop control when the optical output power is adjusted.

### DETAILED DESCRIPTION OF THE PREFERRED EMBODIMENTS

Exemplary embodiments of the present invention will be explained in detail with reference to the accompanying drawings.

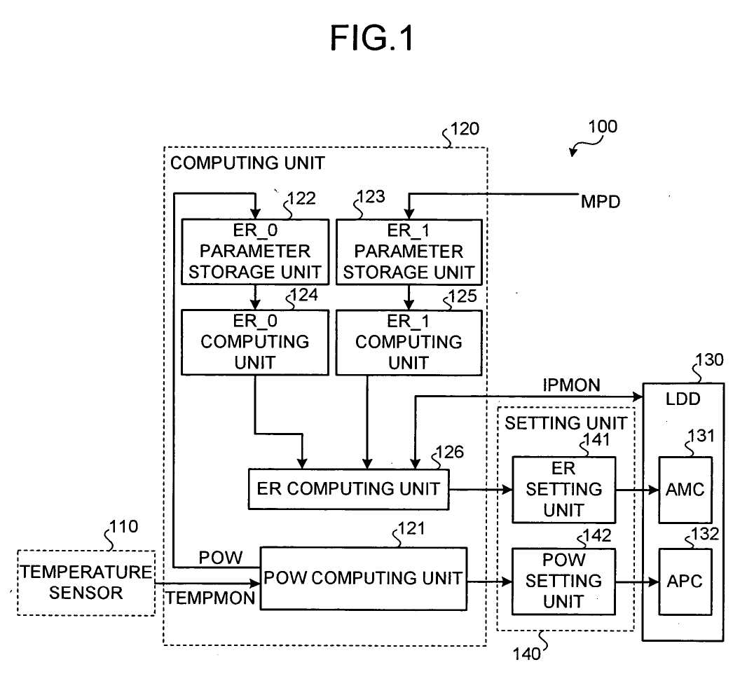

FIG. 1 is a block diagram of a basic configuration of an extinction ratio control apparatus according to an embodiment of the present invention. For controlling the extinction ratio of a light-emitting device, for example, a laser diode (hereinafter, “LD”) (not shown) connected thereto, the extinction ratio control apparatus 100 includes a temperature sensor 110, a computing unit 120, a laser diode driver (hereinafter, “LDD”) 130, and a setting unit 140.

The temperature sensor 110 detects the temperature of the LD, and outputs the detected value (hereinafter, “TEMPMON”) to the computing unit 120. The computing unit 120 includes a POW computing unit 121, an ER_0 parameter storage unit 122, an ER_1 parameter storage unit 123, an ER_0 computing unit 124, an ER_1 computing unit 125, and an ER computing unit 126. The POW computing unit 121 computes the power control value (hereinafter, “POW”) of the LD based on the TEMPMON input from the temperature sensor 110, and outputs the POW to the setting unit 140 and the ER_0 parameter storage unit 122.

The computing unit 120 calculates the extinction ratio (hereinafter, “ER”) corresponding to the value of the modulation current Ip (hereinafter, “IPMON”) input from the LDD 130. In the present embodiment, it is assumed that the ER is represented by a linear function of the IPMON. The ER_0 computing unit 124 calculates a zero-order coefficient ER_0 indicating the intercept of the linear function. The ER_1 computing unit 125 calculates a first-order coefficient ER_1 indicating the slope of the linear function.

The ER_0 parameter storage unit 122 stores information on the characteristic of the POW. When the POW is input into the ER_0 parameter storage unit 122 from the POW computing unit 121, relevant information is extracted from the ER_0 parameter storage unit 122, and input into the ER_0 computing unit 124 that calculates the coefficient ER_0 and outputs the coefficient ER_0 to the ER computing unit 126.

On the other hand, the ER_1 parameter storage unit 123 stores information on the characteristic of a power monitor value of the LD detected by the monitor photo diode (hereinafter, “MPD”). When the power monitor value is input into the ER_1 parameter storage unit 123 from the MPD, relevant information is extracted from the ER_1 parameter storage unit 123, and input into the ER_1 computing unit 125 that calculates the coefficient ER_1 and outputs the coefficient ER_1 to the ER computing unit 126.

Into the ER computing unit 126, not only the coefficient ER_0 calculated by the ER_0 computing unit 124 and the coefficient ER_1 calculated by the ER_1 computing unit 125, but also the IPMON detected by the LDD 130 is input. The ER computing unit 126 calculates the ER based on the coefficients ER_0 and ER_1 and the variable IPMON (in other words, using the linear function), and output the ER to the setting unit 140.

The setting unit 140 includes an ER setting unit 141 and a POW setting unit 142. The ER setting unit 141 sets (outputs) the ER input from the ER computing unit 126 to an AMC 131 of the LDD 130, which controls the extinction ratio based on the ER input from the ER setting unit 141. The POW setting unit 142 sets (outputs) the POW input from the POW computing unit 121 to an APC 132 of the LDD 130, which controls the optical output power based on the POW input from the POW setting unit 142.

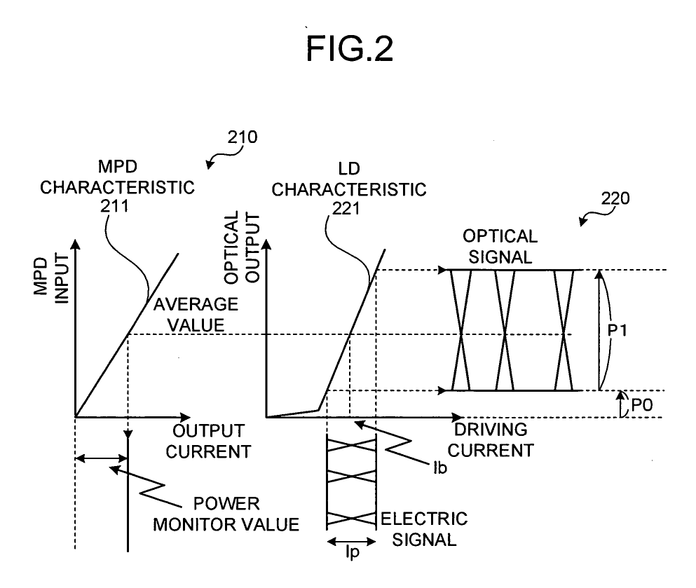

FIG. 2 is a diagram for explaining the relation between the MPD characteristic and the LD characteristic. A chart 210 shows an MPD characteristic 211 representing the relation between the intensity of the light input into the MPD (the vertical axis) and the current output from the MPD (the horizontal axis). The MPD outputs the average value of the optical output power of the LD as the power monitor value. A chart 220 shows the LD characteristic 221 representing the relation between the driving current input into the LD (the horizontal axis) and the intensity of the light output from the LD (the vertical axis).

Assume that, for example, an electric signal containing the bias current Ib and the modulation current Ip is input into the LD. The optical output power of the LD varies within the range of P1 due to the amplitude of the modulation current Ip. Using the range P1 and the range P0 from the value of zero (0) to the lower limit of the range P1, the extinction ratio is expressed as the following equation (1).
Extinction Ratio [dB]=10 log(P1/P0) (1)

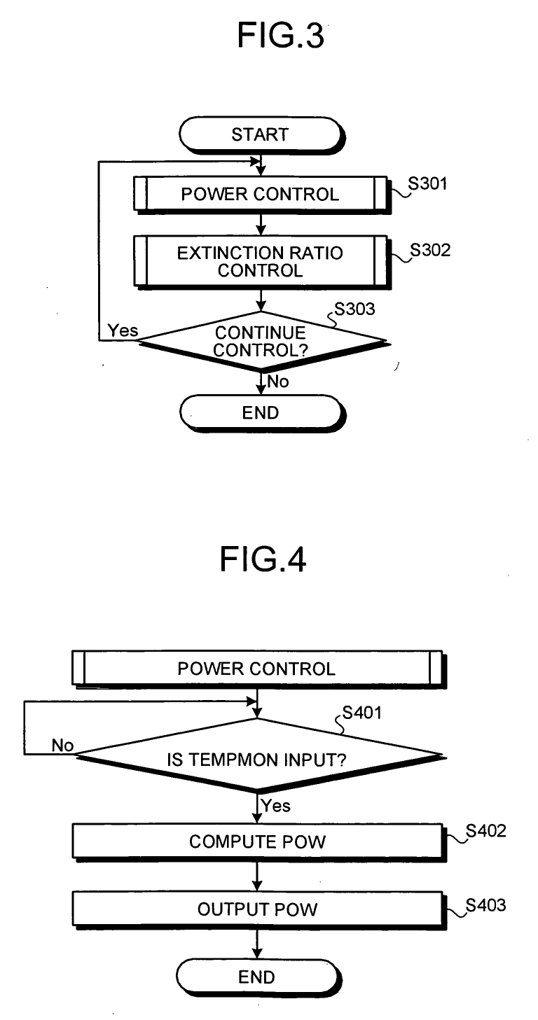

FIG. 3 is a flowchart of a control process performed by the computing unit 120. Since the calculation of ER requires the POW, the computing unit 120 performs the power control first (step S301), and then performs the extinction ratio control (step S302). Then, it is determined whether to continue the control (step S303). If the control is determined to be continued (step S303: Yes), the process is returned to step S301 and the series of the above steps is performed repeatedly. If the control determined to be ended (step S303: Yes), the process is ended there.

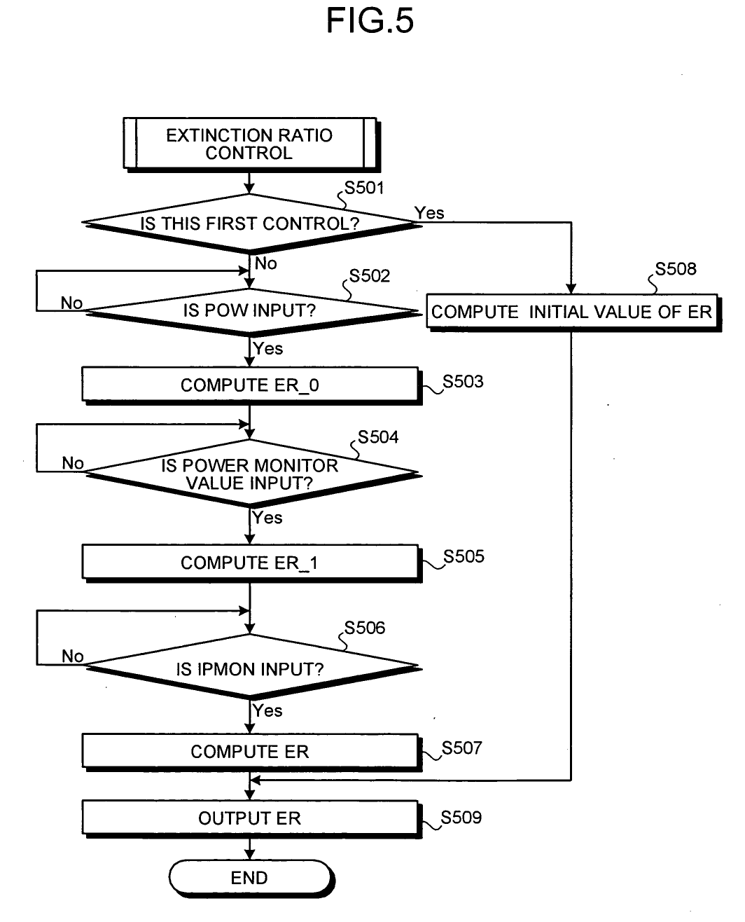

FIG. 4 is a flowchart of the power control process performed at step S301 shown in FIG. 3. The computing unit 120 determines whether the TEMPMON has been input into the POW computing unit 121 from the temperature sensor 110 (step S401). If the TEMPMON has been input (step S401: Yes), the computing unit 120 computes the POW by the POW computing unit 121 (step S402), and outputs the POW to the ER_0 parameter storage unit 122 and the POW setting unit 142 of the setting unit 140 (step S403).

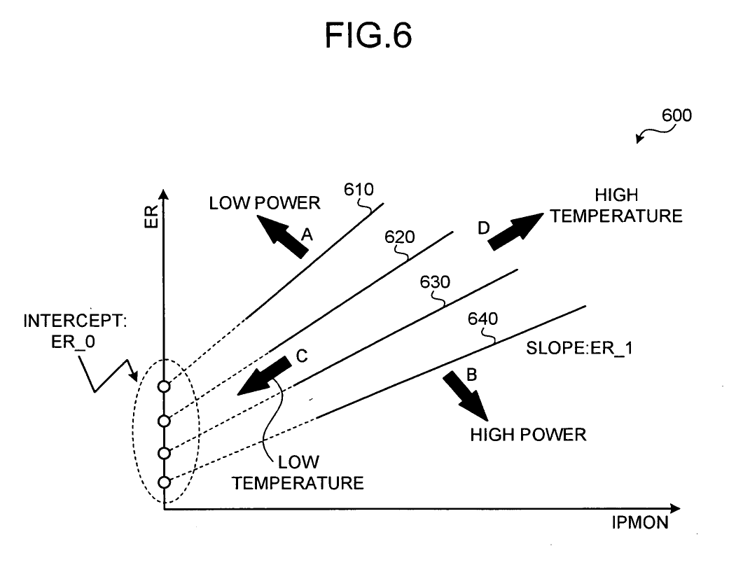

FIG. 5 is a flowchart of the extinction ratio control process performed at step S302 shown in FIG. 3. The computing unit 120 determines whether the present control is the first control (step S501). If the present control is not the first control (step S501: No), the computing unit 120 determines whether the POW has been input into the ER_0 parameter storage unit 122 from the POW computing unit 121 (step S502).

If the POW has been input (step S502: Yes), the ER_0 computing unit 124 of the computing unit 120 computes, as a first extinction ratio control information, the coefficient ER_0 based on the POW and its characteristic information stored in the ER_0 parameter storage unit 122 (step S503).

Then, the computing unit 120 determines whether the power monitor value has been input into the ER_1 parameter storage unit 123 from the MPD (step S504). If the power monitor value has been input (step S504: Yes), the ER_1 computing unit 125 of the computing unit 120 computes, as a second extinction ratio control information, the coefficient ER_1 based on the power monitor value and its characteristic information stored in the ER_1 parameter storage unit 123 (step S505).

Then, the computing unit 120 determines whether the IPMON has been input into the ER computing unit 126 from the LDD 130 (step S506). If the IPMON has been input (step S506: Yes), the ER computing unit 126 of the computing unit 120 computes the ER based on the first extinction ratio control information and the second extinction ratio control information (step S507), and outputs the ER to the AMC 131 of the LDD 130 through the ER setting unit 141 of the setting unit 140 (step S509).

On the other hand, if the present control is determined to be the first control (step S501: Yes), the computing unit 120 calculates an initial value of the ER (step S508), and outputs the initial value to the AMC 131 of the LDD 130 through the ER setting unit 141 of the setting unit 140 (step S509).

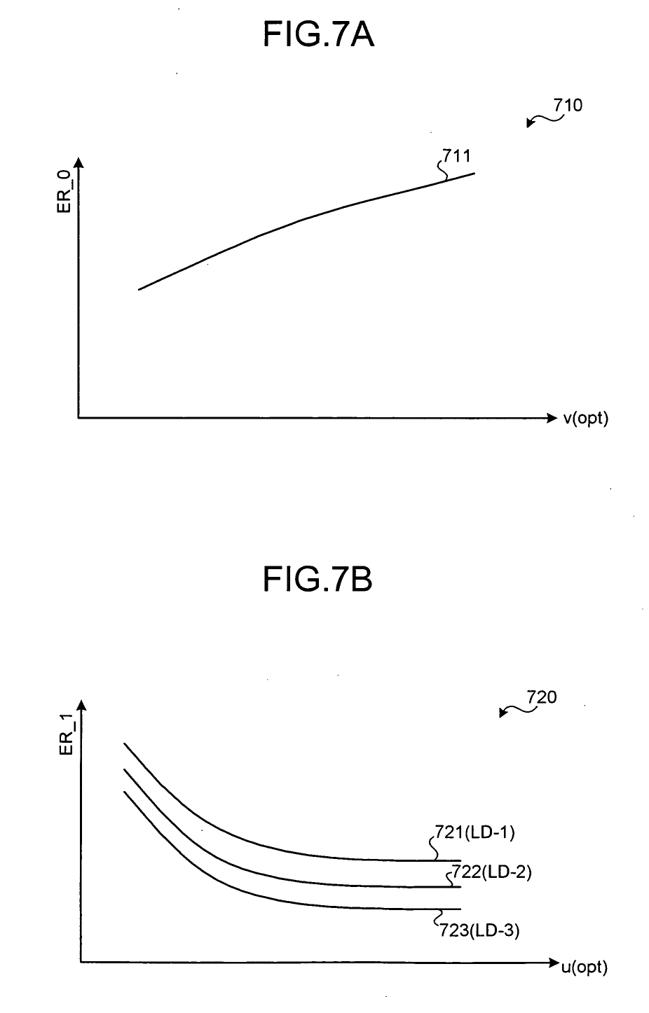

FIG. 6 is a diagram for explaining the relation between the IPMON and the ER. The horizontal axis of a chart 600 represents the IPMON while the vertical axis of the chart 600 represents the ER. Straight lines 610 to 640, which are expressed by the following equation (2), represent functions used in the computation performed by the ER computing unit 126.
ER=ER_{—}1(u(opt))×IPMON+ER_{—}0(v(opt)) (2)

The computing unit 120 generates, for each extinction ratio control, an optimal function based on the POW calculated by the POW computing unit 121 and the power monitor value input from the MPD. Specifically, the computing unit 120 generates the function represented by the straight line 610 when the optical output power of the LD is set at a low value, and generates the function represented by the straight line 640 when the optical output power of the LD is set at a high value. In other words, the lower the optical output power of the LD is, the larger the coefficients ER_0 and ER_1, which are input into the ER computing unit 126 from the ER_0 computing unit 124 or the ER_1 computing unit 125, become (see an arrow A shown in FIG. 6), and the higher the optical output power of the LD is, the smaller the coefficients ER_0 and ER_1 become (see an arrow B shown in FIG. 6). On the other hand, since the IPMON input into the ER computing unit 126 from the MPD becomes smaller/larger when the temperature of the LD is low/high, the ER, which is calculated by the ER computing unit 126 using the above equation (2), becomes small when the temperature of the LD is low (see an arrow C shown in FIG. 6) and becomes large when the temperature of the LD is high (see an arrow D shown in FIG. 6).

The value of the variable “v(opt)” in the above equation (2) is determined by the POW, and is stored in the ER_0 parameter storage unit 122. The value of the variable “u(opt)” is determined by the power monitor value input from the MPD, and is stored in the ER_1 parameter storage unit 123.

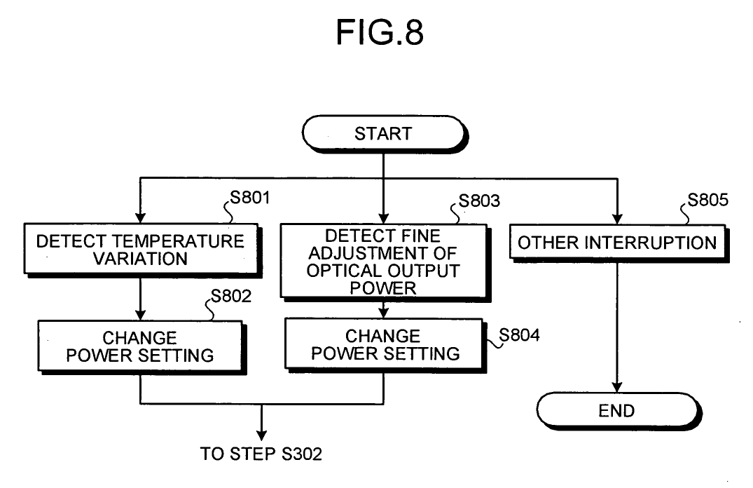

FIG. 7A is a diagram for explaining the relation between the variable v(opt) and the coefficient ER_0. The horizontal axis of a chart 710 represents the variable v(opt) while the vertical axis of the chart 710 represents the coefficient ER_0. The value of the coefficient ER_0 is represented by a curve 711, which is a function of the variable v(opt) determined by the POW.

FIG. 7B is a diagram for explaining the relation between the variable u(opt) and the coefficient ER_1. The horizontal axis of a chart 720 represents the variable u(opt) while the vertical axis of the chart 720 represents the coefficient ER_1. The value of the coefficient ER_1 is represented by a curve 721, 722, or 723, each of which is a function of the valuable v(opt) determined by the power monitor value of the LD detected by the MPD. The function is an approximated equation that is specific to each LD and determined based on actual measurement values of each LD. The curves 721, 722, and 723 represent functions for an LD-1, an LD-2, and an LD-3, respectively.

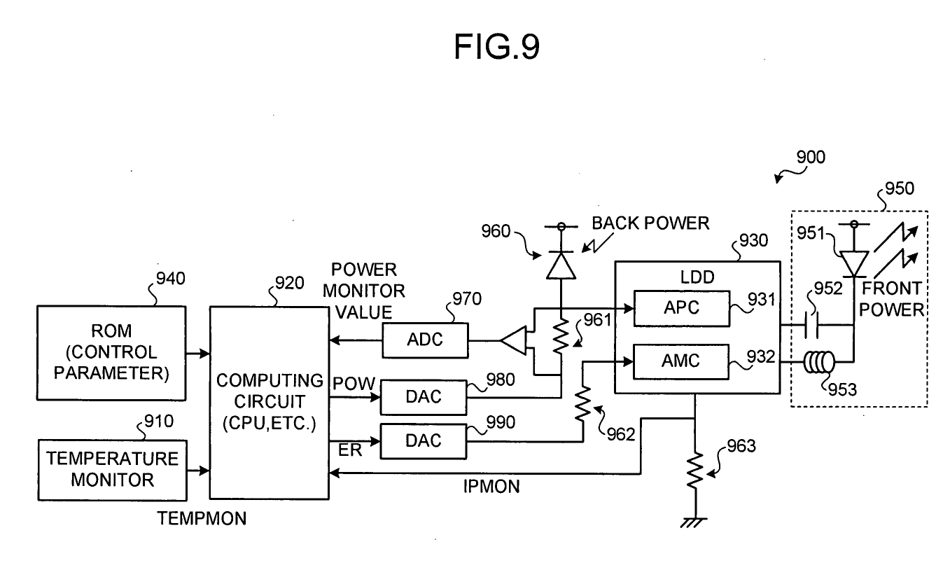

FIG. 8 is a flowchart of a modification of the control process shown in FIG. 3. The flowchart shows a control process when an interruption occurs after the start of the control.

When a temperature variation occurs after the start of the control, the temperature variation is detected (step S801) and the power setting is changed according to the temperature variation (step S802). Then, the process proceeds to step S302 shown in FIG. 3.

When the optical output power is fine-adjusted after the start of the control, the fine-controlled power is detected (step S803) and the power setting is changed according to the fine-controlled power (step S804). Then, the process proceeds to step S302 shown in FIG. 3.

When other interruptions, which do not affect the settings of the extinction ratio control, occur after the start of the control, corresponding interruption process is executed (step S805) and the control process is ended there.

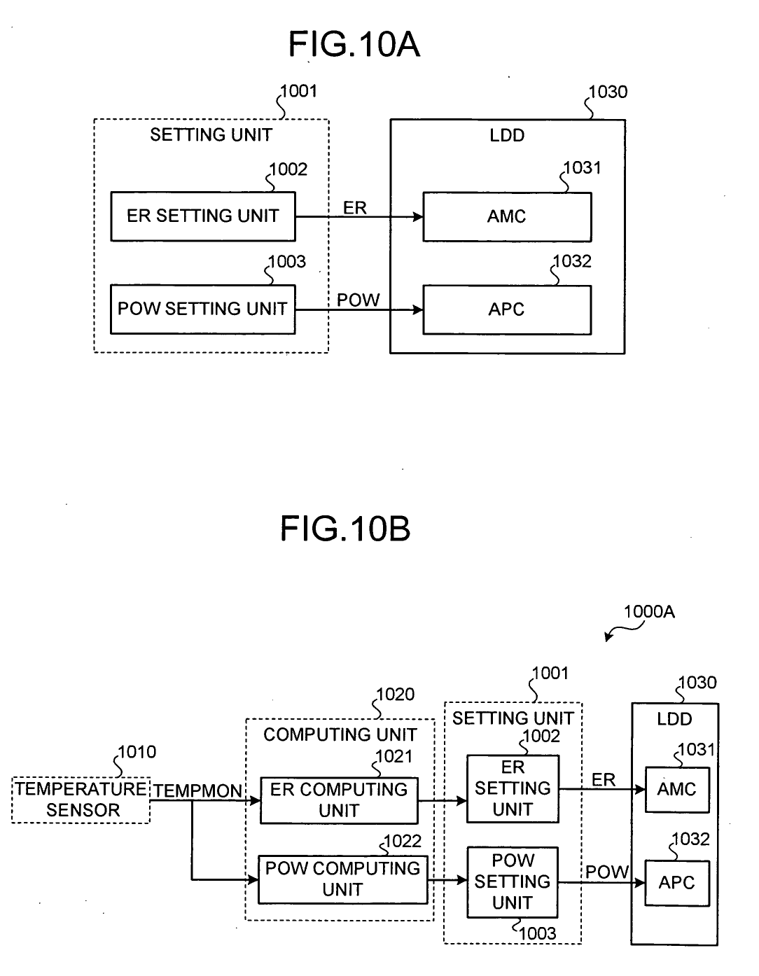

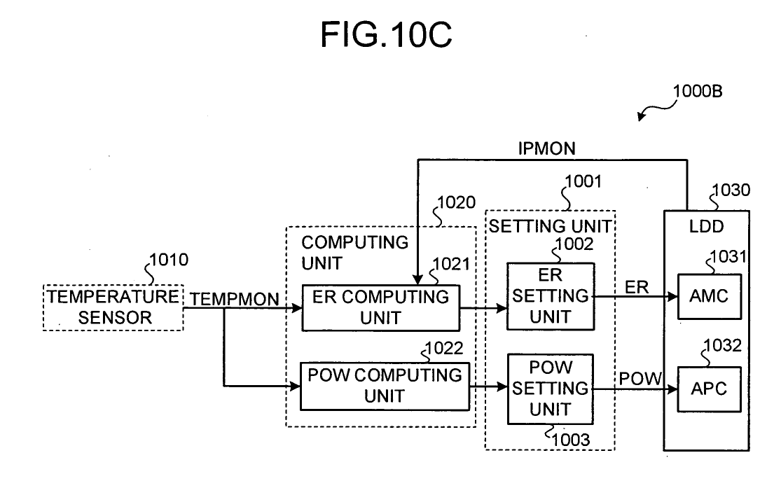

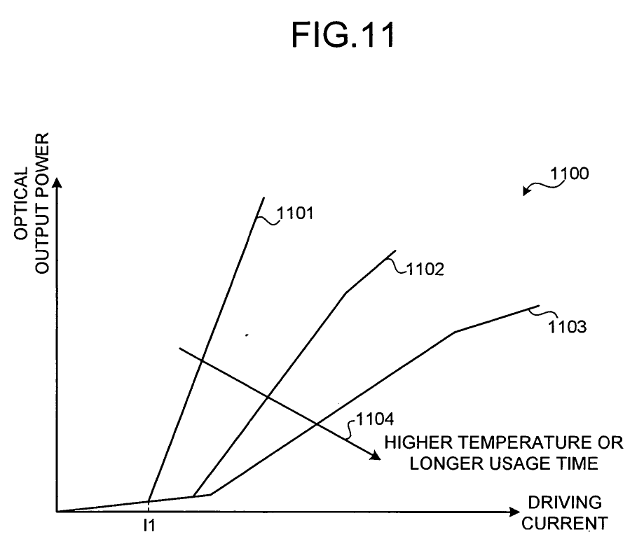

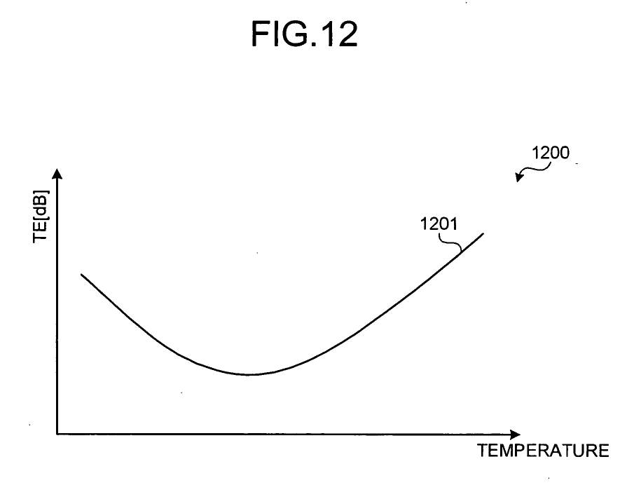

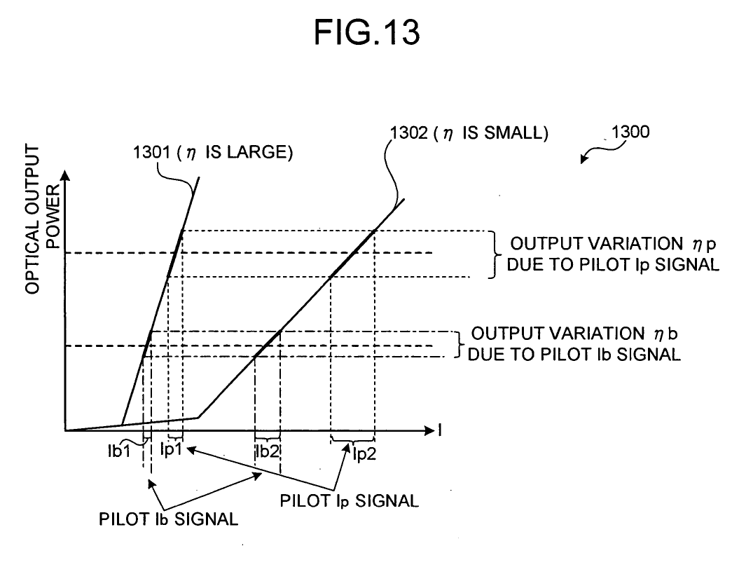

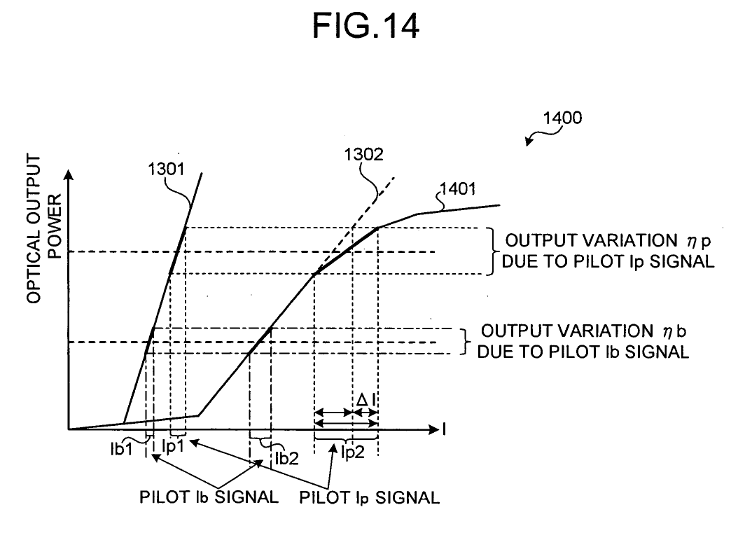

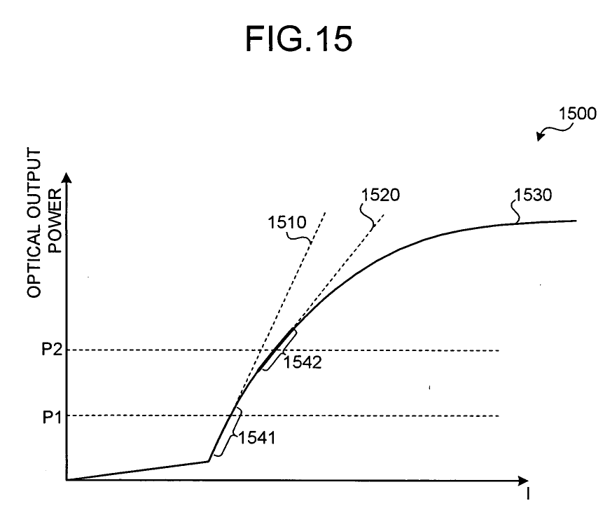

FIG. 9 is a block diagram of a detailed configuration of an extinction ratio control apparatus according to an embodiment of the present invention. An extinction ratio control apparatus 900 shown in FIG. 9 is a specific example of the extinction ratio control apparatus 100 shown in FIG. 1. The extinction ratio control apparatus 900 includes a temperature monitor 910, a computing circuit 920, an LDD 930, a ROM 940, an LD unit 950 including an LD 951, a capacitor 952, and an inductor 953, an MPD 960, an analog-to-digital converter (hereinafter, “ADC”) 970, and digital-to-analog converters (hereinafter, “DACs”) 980 and 990.

The temperature monitor 910 monitors the temperature of the LD 951 of the LD unit 950, and outputs the temperature to the computing circuit 920 as the TEMPMON. The ROM 940 corresponds to the ER_0 parameter storage unit 122 and the ER_1 parameter storage unit 123 shown in FIG. 1, and stores the control parameters. The computing circuit 920 calculates the POW based on the TEMPMON input from the temperature monitor 910, the control parameters input from the ROM 940, and the power monitor value input from the MPD 960 through the ADC 970, and outputs the POW to the DAC 980. The computing circuit 920 also calculates the ER based on the POW, the control parameters input from the ROM 940, and the IPMON input from the LDD 930, and outputs the ER to the DAC 990.

The LDD 930 includes an APC 931 and an AMC 932. The APC 931 controls the optical output power of the LD unit 950 based on the POW input from the DAC 980. The AMC 932 controls the extinction ratio of the LD unit 950 based on the ER input from the DAC 990. The LDD 930 is connected to the ground through a resistor 963, and outputs the IPMON, which is the detected value of the modulation current Ip input into the LDD 930, to the computing circuit 920.

The LD unit 950 includes the LD 951, the capacitor 952 and the inductor 953, and outputs light (“FRONT POWER” shown in FIG. 9) corresponding to the driving current input from the LDD 930. Returning light output from the LD 951 (“BACK POWER” shown in FIG. 9) is input into the MPD 960, which generates a current corresponding to the input light. The current is input into the computing circuit 920 as the power monitor value after being converted into a digital signal by the ADC 970.

The DAC 980 converts the POW input from the computing circuit 920 into an analog signal and outputs the analog signal to the APC 931 through a resistor 961. The DAC 990 converts the ER input from the computing circuit 920 into an analog signal and outputs the analog signal to the AMC 932 through a resistor 962.

As described above, the extinction ratio control apparatuses 100 and 900 can keep the optical output power and the extinction ratio at an optimal value even when the IL characteristic of the LD changes according to the temperature or the usage time. Furthermore, the apparatuses 100 and 900 can control the extinction ratio to be constant even when the optical output power is adjusted, since the apparatuses 100 and 900 calculate the ER based on the POW.

Furthermore, conventionally, when the TE correction and the extinction ratio control associated with the TE correction are executed, actual measurement values or high precision estimated values of the TE at various temperatures at which the LD is used have been required. According to the interruption process shown in FIG. 8, however, all the parameters can be determined using only information obtained through the adjustment, and therefore the actual measurement values or high precision estimation values becomes unnecessary.

The extinction ratio control method described above can also be implemented by executing a program prepared in advance on a computer such as a personal computer or a work station. This program is executed through being recorded in and read from a computer-readable recording medium such as a hard disk. This program may be contained in a transmissible medium that can be distributed through networks such as the Internet.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for controlling an extinction ratio of a light-emitting device, comprising:
a temperature detecting unit that detects a temperature of the light-emitting device;
a power detecting unit that detects an optical output power of the light-emitting device;
a modulation-current detecting unit that detects a modulation current input into the light-emitting device;
a power-control-value computing unit that computes a power control value for the light-emitting device based on the temperature; and
an extinction-ratio-control-value computing unit that computes an extinction ratio control value for the light-emitting device based on the power control value, the optical output power, and the modulation current.

2. The apparatus according to claim 1, further includes a characteristic-information storage unit that stores characteristic information on a characteristic of the light-emitting device, wherein
the extinction-ratio-control-value computing unit includes a correction-information calculating unit that calculates correction information for collecting a nonlinear characteristic of the extinction ratio control value based on any one of the characteristic information corresponding to the power control value and the characteristic information corresponding to the optical output power.

3. An apparatus according to claim 1, wherein the extinction-ratio-control-value computing unit computes the extinction ratio control value using a function having the modulation current as a variable and the correction information as a coefficient.

4. The apparatus according to claim 2, wherein the correction-information calculating unit includes:
a first-coefficient calculating unit that calculates a first coefficient based on the power control value and characteristic information on a variation of the power control value stored in the characteristic-information storage unit; and
a second-coefficient calculating unit that calculates a second coefficient based on the optical output power and the characteristic information on a variation of the optical output power stored in the characteristic-information storage unit, wherein
the extinction-ratio-control-value computing unit computes the extinction ratio control value using a linear function having the first coefficient and the second coefficient.

5. The apparatus according to claim 4, wherein the characteristic information on the variation of the power control value is an approximated equation derived from a value of an intercept of the linear function for each power control value.

6. The apparatus according to claim 4, wherein the characteristic information on the variation of the optical output power is an approximated equation derived from a value of a slope of the linear function for each power control value specific to each light-emitting device.

7. The apparatus according to claim 2, wherein the correction-information calculating unit stores the correction information, and the power control value and the optical output power that are used for a calculation of the correction information, into the characteristic-information storage unit when a temperature of the light-emitting device is changed.

8. The apparatus according to claim 2, wherein the correction-information calculating unit stores the correction information, and the power control value and the optical output power that are used for a calculation of the correction information, into the characteristic-information storage unit when a setting of the optical output power is changed.

9. A method of controlling an extinction ratio of a light-emitting device, comprising:
detecting a temperature of the light-emitting device;
detecting an optical output power of the light-emitting device;
detecting a modulation current input into the light-emitting device;
computing a power control value for the light-emitting device based on the temperature; and
computing an extinction ratio control value for the light-emitting device based on the power control value, the optical output power, and the modulation current.

10. A computer-readable recording medium that stores a computer program for controlling an extinction ratio of a light-emitting device, wherein the computer program causes a computer to execute:
detecting a temperature of the light-emitting device;
detecting an optical output power of the light-emitting device;
detecting a modulation current input into the light-emitting device;
computing a power control value for the light-emitting device based on the temperature; and
computing an extinction ratio control value for the light-emitting device based on the power control value, the optical output power, and the modulation current.
